(19) United States
(12) Patent Application Publication
(10) Pub. No.: US 2005/0020452 A1
(43) Pub. Date: Jan. 27, 2005

(54) Coaxial connector and method for fabricating the same, and superconducting device

(75) Inventors: Teru Nakanishi, Kawasaki (JP); Akihiko Akasegawa, Kawasaki (JP); Kazunori Yamanaka, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/921,195

(22) Filed: Aug. 19, 2004

Related U.S. Application Data
(63) Continuation of application No. PCT/JP03/01467, filed on Feb. 13, 2003.

(30) Foreign Application Priority Data
Mar. 25, 2002 (JP) 2002-83450

(51) Int. Cl. H01F 1/00

(52) U.S. Cl. 505/100

(57) ABSTRACT

A coaxial connector 10 to be connected to a coaxial cable comprising a surface coating layer 20 of indium or an indium alloy being formed on the surface of a terminal 12 which is a central conductor. Since indium similar to an indium-based solder material is used as the material of the surface coating layer 20, a reaction product is prevented from being produced in indium-based solder by the reaction between the material of the surface coating layer 20 and the material of the indium-based solder material. Accordingly, deterioration of the flexibility of the indium-based solder can be prevented, and a superconducting device which can endure the repeated temperature changes between the room temperature and lower temperatures can be provided.

### CROSS REFERENCE TO RELATED APPLICATION

This application is a Continuation of PCT International Application No. PCT/JP03/01467, with an international filing date of Feb. 13, 2003, which designating the United States of America.

### TECHNICAL FIELD

The present invention relates to a coaxial connector and a method for fabricating the coaxial connector, and a superconducting device.

### BACKGROUND ART

Superconducting filters using superconductors are recently much noted because of their frequency characteristics which are better in comparison with the generally used filters using electrically good conductors.

Superconducting filters are mounted in metal packages which are electromagnetic shielding to radio frequencies, and are cooled to 70K by, e.g., freezers to be used.

The proposed superconducting device with the superconducting filter mounted will be explained with reference to FIG. 5. FIG. 5 is sectional views of the proposed superconducting device. FIG. 5A illustrates the superconducting device before soldering. FIG. 5B illustrates the superconducting device after soldering.

As illustrated in FIG. 5B, a superconducting filter 126 is mounted in a metal package 124. The superconducting filter 126 comprises a dielectric substrate 128, a pattern 130 of a superconductor film formed on the dielectric substrate 128, and a ground plane 136 formed below the dielectric substrate 128. Electrodes 134 are formed on the ends of the pattern 130, and a ground electrode 138 is formed below the ground plane 136.

At the ends of the metal package 124, coaxial connectors 110 for electrically connecting coaxial cables (not shown) to the superconducting filter 126 are provided. The coaxial connectors 110 function as receptacles. Each coaxial connector 110 comprises a terminal 112 of central conductor, an insulator 114, a coupling 116 and a body 118.

The terminal 112 of the coaxial connector 110 is connected to the electrode 134 of the superconducting filter 126 by an indium-based solder 142.

An indium-based solder is used in connecting the terminal 112 of the coaxial connector 110 to the electrode 134 of the superconducting filter 126, because the indium-based solders have good flexibility not only at the room temperature but also lower temperatures. In connecting the terminal of the coaxial connector to the superconducting filter by the ordinary Sn-37% Pb solder, when the temperature is changed between the room temperature and lower temperatures, large stresses are applied to the solder junction due to the thermal expansion coefficient differences between the metal package 124 and the superconducting filter 126, and the soldered connection is released. In using an indium-based solder, even when the temperature is changed between the room temperature and lower temperatures, because of the good flexibility of the indium-based solder not only at the room temperature but also at lower temperatures, the stresses to be applied to the connection due to the thermal expansion coefficient differences between the metal package 124 and the superconducting filter 126 could be mitigated even when the temperature is changed between the room temperature and lower temperatures.

In the proposed superconducting device, the coaxial cable and the superconducting filter can be electrically connected to each other with the coaxial connector, which facilitates the connecting operations of the machines and apparatuses.

However, as illustrated in FIG. 5A, a surface coating layer 120 of a several μm-thickness Au film is formed on the surface of the terminal 112 of the ordinary coaxial connector 110. When the terminal 112 having such surface coating layer 120 of Au is connected to the electrode 134 of the superconducting filter 126 with an indium-based solder, the Au of the surface coating layer 120 is diffused in the indium-based solder 142. Then, as illustrated in FIG. 5B, a reaction product 145 between the Au and the In (indium) is produced in the indium-based solder 142. The indium-based solder 142 having such reaction product 145 has poor flexibility and is broken when the ambient temperature is repeatedly changed between the room temperature and lower temperatures. Thus, when the terminal 112 of the coaxial connector 110 and the electrode 134 of the superconducting filter 126 are connected to each other simply with the indium-based solder 142, the superconducting device has not been highly reliably durable to repeated temperature changes between the room temperature and lower temperatures.

An object of the present invention is to provide a coaxial connector which is durable to repeated temperature changes between the room temperature and lower temperatures even when the coaxial connector is connected with an indium solder and a method for fabricating the coaxial connector, and a superconducting device using the coaxial connector.

### DISCLOSURE OF THE INVENTION

The above-described object is achieved by a coaxial connector to be connected to a coaxial cable, a surface coating layer of indium or an indium alloy being formed on the surface of a terminal of central conductor.

The above-described object is achieved by a coaxial connector to be connected to a coaxial cable, a terminal of central conductor being formed of Ag or an Ag alloy.

The above-described object is achieved by a method for fabricating a coaxial connector to be connected to a coaxial cable, comprising the step of forming a surface coating layer of indium or an indium alloy on the surface of a terminal of central conductor.

The above-described object is achieved by a superconducting device comprising a coaxial connector to be connected to a coaxial cable, and a superconducting element to be connected to the coaxial cable by the coaxial connector, a surface coating layer of indium or an indium alloy being formed on the surface of a terminal of central conductor of the coaxial cable, and the terminal and an electrode of the superconducting element being connected to each other by an indium-based solder.

The above-described object is achieved by a superconducting device comprising a coaxial connector to be connected to a coaxial cable, and a superconducting element to be connected to the coaxial cable by the coaxial connector, a terminal of central conductor of the coaxial connector being formed of Ag or an Ag alloy.

According to the present invention, even in a case that the terminal of the coaxial connector and the electrode of the superconducting device are connected to each other by an indium-based solder, the deterioration of the flexibility of the indium-based solder can be prevented. Thus, the present invention can provide a superconducting device which can endure the repeated temperature changes between the room temperature and lower temperatures.

### BRIEF DESCRIPTION OF THE DRAWINGS

FIG. 1 is a side view of the coaxial connector according to a first embodiment of the present invention.

FIGS. 2A and 2B are diagrammatic views of the superconducting device according to the first embodiment of the present invention.

FIG. 3 is a side view of the coaxial connector according to a second embodiment of the present invention.

FIG. 4 is a side view of the coaxial connector according to a third embodiment of the present invention.

FIGS. 5A and 5B are sectional views of the proposed superconducting device.

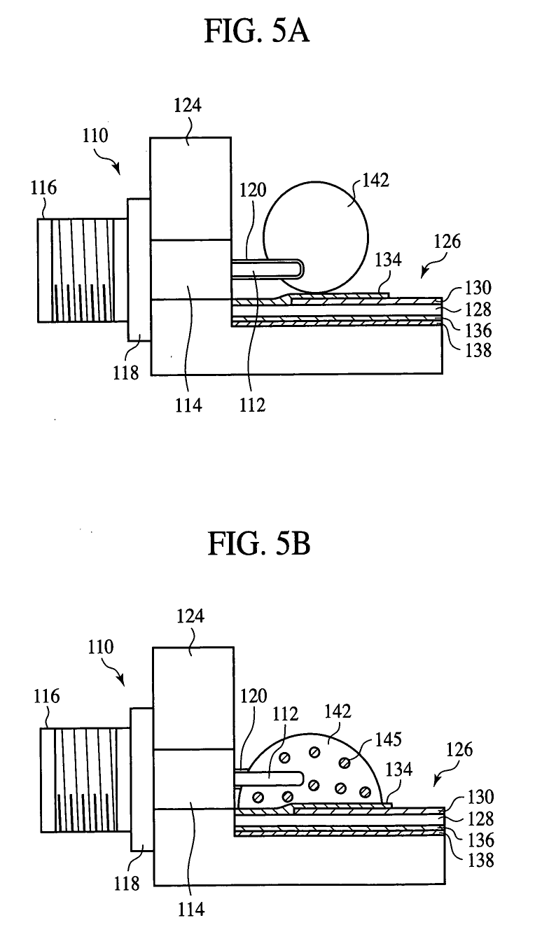

### BEST MODES FOR CARRYING OUT THE INVENTION

(A First Embodiment)

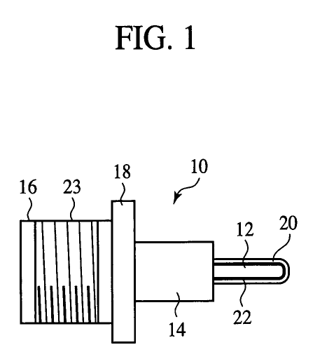

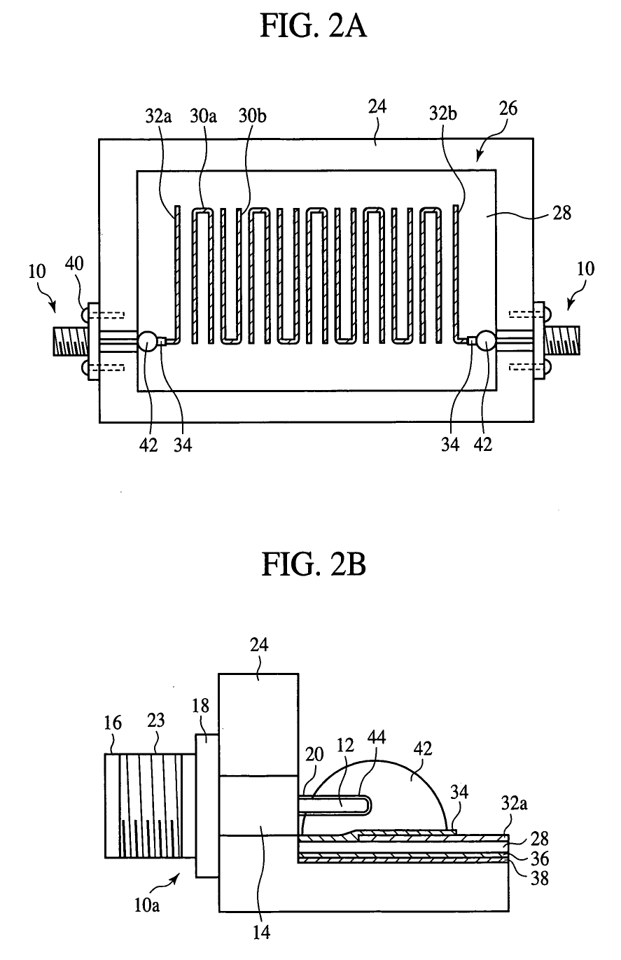

The coaxial connector according to a first embodiment of the present invention and the method for fabricating the coaxial connector, and the superconducting device using the coaxial connector will be explained with reference to FIGS. 1 to 2B.

(The Coaxial Connector)

First, the coaxial connector according to the present embodiment will be explained with reference to FIG. 1. FIG. 1 is a side view of the coaxial connector according to the present embodiment. The end of the terminal, however, is shown in section.

As illustrated in FIG. 1, the coaxial connector 10 comprises a terminal 12 of central conductor, a cylindrical insulator 14 of a fluorine-based resin formed around the terminal 12, a cylindrical coupling 16 which is an outer conductor formed around the insulator 14, and a body 18 supporting the terminal 12, the insulator 14 and a coupling 16.

The axial connector 10 is of SMA (SUB-MINIATURE TYPE A) and functions as a receptacle.

The end of the terminal 12 on the right side of the drawing is rod-shaped. The material of the terminal 12 is, e.g., Cu. A surface coating layer 20 of a 20 μm-thickness indium (In) layer is formed on the surface of the terminal 12. Because of the surface coating layer 20 of indium formed on the surface of the terminal 12, good wettability can be obtained when the terminal 12 and the electrode (see FIG. 2) of the superconducting filter are connected with each other with an indium-based solder.

In the present specification, the indium-based solder means pure indium, a binary alloy containing indium, a ternary or more alloy containing indium as the main component, or others.

A reaction layer 22 of an indium and Cu alloy is formed in the interface between the terminal 12 and the surface coating layer 20. The reaction layer 22 is formed by the reaction between the indium of the surface coating layer 20 and the Cu of the terminal 12 in forming the surface coating layer 20 on the surface of the terminal 12.

Screw threads 23 are formed on the outside of the coupling 16. The coupling 16 functions as the male connection part when the coupling 16 is connected to the coaxial connector (not shown) of a coaxial cable (not shown) by screw-engagement.

Thus, the coaxial connection according to the present embodiment is constituted.

(The Superconducting Device)

Next, the superconducting device using the coaxial connector according to the present embodiment will be explained with reference to FIG. 2. FIGS. 2A and 2B are diagrammatic views of the superconducting device according to the first embodiment of the present invention. FIG. 2A is a plan view, and FIG. 2B is a sectional view.

As illustrated in FIG. 2A, the superconducting device according to the present embodiment comprises a metal package 24, a superconducting filter 26 mounted in the metal package 24, and coaxial connector 10 for electrically connecting the superconducting filter 26 and a coaxial cable (not shown).

The metal package 24 is formed of, e.g., an Al alloy. The outer dimensions of the metal package 24 are, e.g., 54 mm×48 mm×13.5 mm.

The superconducting filter 26 which is a 2 GHz-band-pass filter is mounted in the metal package 24.

Then, the superconducting filter 26 will be explained.

As the substrate of the superconducting filter 26, a dielectric substrate 28 of MgO single crystal is used. The dimensions of the dielectric substrate 28 are, e.g., 38 mm×44 mm×0.5 mm.

On the dielectric substrate 28, there are alternately formed ½-wavelength type hairpin patterns 30a, 30b of a high temperature superconducting film (hereinafter called “a YBCO-based high temperature superconducting film”) of YBa₂Cu₃O_{X} (X=6.5-7) as a main component. The hairpin patterns 30a and the hairpin patterns 30b are arranged generally in one row. Totally nine hairpin patterns 30a, 30b are arranged. On the dielectric substrate 28 on both sides of the one row of the hairpin patterns 30a, 30b, ¼ wavelength type feeder line patterns 32a, 32b of a YBCO-based high temperature superconducting film are formed.

The hairpin patterns 30a, 30b, and the feeder line patterns 32a, 32b can be formed by forming a YBCO-based high temperature superconducting film by laser deposition and patterning the YBCO-based high temperature superconducting film by photolithography.

Electrodes 34 of an Ag/Pd/Ti structure are formed respectively at the ends of the feeder line patterns 32a, 32b. The electrodes 34 can be formed by sequentially laying a Ti film, a Pd film and an Ag film by, e.g., vapor deposition.

As illustrated in FIG. 2B, a ground plane 36 of a YBCO-based high temperature superconducting film is formed on the underside of the dielectric substrate 28. The ground plane 36 is formed solid. The YBCO-based high temperature superconducting film forming the ground plane 36 can be formed by, e.g., laser deposition.

A ground electrode 38 of an Ag/Pd/Ti structure is formed below the ground plane 36. The ground electrode 38 is formed solid. The ground electrode 38 can be formed by sequentially laying a Ti film, a Pd film and an Ag film by, e.g., vapor deposition.

Thus, the superconducting filter 26 is constituted. This superconducting filter 26 functions as, e.g., a 2 GHz-band-pass filter of microstrip line type.

The ground electrode 38 of the superconducting filter 26 is electrically connected to the metal package 24.

Coaxial connectors 10 are mounted on both ends of the metal package 24. The coaxial connector 10 is fixed to the metal package 24 with screws 40.

The coaxial connector 10 on the left side of the drawing of FIG. 2A is connected to the coaxial connector (not shown) of the coaxial cable (not shown) on the input side. The coaxial connector 10 on the right side of the drawing of FIG. 2B is connected to the coaxial connector (not shown) of the coaxial cable (not shown) on the output side. As described above, the coaxial connector (not shown) of the coaxial cable (not shown) and the coaxial connector 10 are connected to each other by screw-engagement.

The terminal 12 of the coaxial connector 10 and the electrode 34 of the superconducting filter 28 are connected to each other with an indium-based solder 42.

At the junction between the terminal 12 and the indium-based solder 42, a reaction product 44 which is an alloy of the Cu and the indium is produced. The reaction product between the Cu and the indium is produced, concentrated near the junction between the terminal 12 and the indium-based solder 42 and is not produced in the indium-based solder 42 remote from the junction between the terminal 12 and the indium-based solder 42. The reaction product between the indium and the Cu is not produced in the region inside the indium-based solder 42 remote from the junction between the terminal 12 and the indium-based solder 42, because when the terminal 12 and the indium-based solder 42 are connected with the indium-based solder 42, the rate of the diffusion of indium of the indium-based solder 42 into the terminal 12 is higher than the rate of the diffusion of Cu of the terminal 12 into the indium-based solder 42.

Thus, the superconducting device according to the present embodiment is constituted.

The superconducting device according to the present embodiment is characterized mainly in that the material of the terminal 12 of the coaxial connector 10 is Cu, and the surface coating layer 20 of indium is formed on the surface of the terminal 12.

As described above, when the terminal of the general coaxial connector having the surface coating layer formed of Au is connected to the electrode of the superconducting filter with an indium-based solder, the Au of the surface coating layer formed on the surface of the terminal is diffused in the indium-based solder, and the reaction product in the indium-based solder is produced. The indium-based solder having such reaction product produced in has poor flexibility, the junction between the indium-based solder and the terminal is broken by repeated cycles of the room temperature and lower temperatures.

In the present embodiment, however, the material of the surface coating layer 20 is indium, as is the material of the indium-based solder, whereby it never take places that the material of the surface coating layer 20 and the material of the indium-based material react with each other to produce the reaction product. Furthermore, Cu used as the material of the terminal 12 is diffused into the indium-based solder 42 at a lower rate than the indium of the indium-based solder 42 is diffused into the terminal 12. Accordingly, the reaction product 44 produced by the reaction between the terminal 12 and the indium-based solder 42 is produced, concentrated near the junction between the terminal 12 and the indium-based solder 42 and is not easily formed in the indium-based solder 42.

Thus, according to the present embodiment, even when the terminal 12 and the indium-based solder 42 are connected with the indium-based solder 42, the production of the reaction produced in the indium-based solder 42 can be prevented. Accordingly, the present embodiment can prevent the deterioration of the flexibility of the indium-based solder 42, whereby the superconducting device can endure repeated temperature changes between the room temperature and lower temperatures.

(Evaluation Result)

Next, the result of evaluating the superconducting device according to the present embodiment will be explained.

The superconducting device was left at 100° C. for 24 hours in order to promote diffuse reaction at a junction between the terminal 12 of the coaxial connector 10 and the indium-based solder 42.

Next, a temperature cycle test in which the ambient temperature was repeatedly changed between the room temperature and a low temperature (70 K) was made.

Resultantly, after 10 cycles, the deterioration of the electric connection between the terminal 12 of the coaxial connector 10 and the electrode 34 of the superconducting filter 26 did not take place.

Based on the above, it is evident that the superconducting device according to the present embodiment can endure repeated temperature changes between the room temperature and lower temperatures.

In a control, the same temperature cycle test was made on the superconducting device using a coaxial connector having the surface coating layer of Au formed on the surface of the terminal of Cu.

Resultantly, before 10 cycles have been repeated, the deterioration of the electric connection between the terminal 12 of the coaxial connector 10 and the electrode 34 of the superconducting filter 26 took place.

(The Method for Fabricating the Coaxial Connector)

Next, the method for fabricating the coaxial connector according to the present embodiment will be explained with reference to FIG. 1.

First, the terminal 12 of Cu is prepared.

Then, a rosin-based flux is applied to the surface of the terminal 12.

Then, the terminal 12 is immersed in a fluxed indium-based solder bath. Then, the surface coating layer 20 of indium is formed on the surface of the terminal 12. At this time, the Cu of the terminal 12 and the indium of the surface coating layer 20 react with each other to form the reaction layer 22 of an alloy of Cu and indium in the interface between the terminal 12 and the surface coating layer 20.

Thus, the terminal 12 having the surface coating layer 20 of indium formed on the surface is formed.

The thus formed terminal 12, the insulator 14, the coupling 16, the body 18, etc. are assembled to fabricate the coaxial connector according to the present embodiment.

(A Second Embodiment)

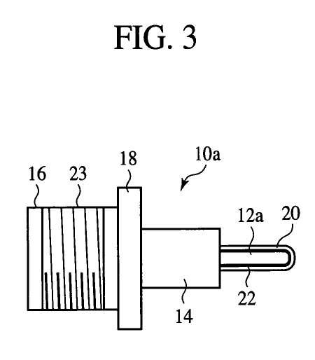

The coaxial connector according to the present embodiment will be explained with reference to FIG. 3. FIG. 3 is a side view of the coaxial connector according to the present embodiment. FIG. 3 illustrates the end of the terminal in section. The same members of the present embodiment as those of the superconducting device according to the first embodiment illustrated in FIGS. 1 and 2 are represented by the same reference numbers not to repeat or to simplify their explanation.

The superconducting device according to the present embodiment is characterized mainly in that the material of the terminal 12a of the coaxial connector 10a is Ni (nickel).

As illustrated in FIG. 3, the terminal 12a of Ni is provided. A surface coating layer 20 of indium is formed on the surface of the terminal 12a.

Ni, which is used as the material of the terminal 12a, is diffused very slowly into an indium-based solder which is used in the connection, and the diffusion into the indium-based solder does not substantially take place. Ni is a material which allows the connection to be made with an indium-based solder.

According to the present embodiment, Ni, which is not substantially diffused into an indium-based solder which is used in the connection is used as the material of the terminal 12a, and furthermore, indium is used as the material of the surface coating layer 20, whereby even in the case the connection is made with an indium-based solder, the production of the reaction product in the indium-based solder can be prevented.

Thus, the superconducting device according to the present embodiment can prevent the deterioration of the flexibility of the indium-based solder and can endure repeated temperature changes between the room temperature and lower temperatures.

(A Third Embodiment)

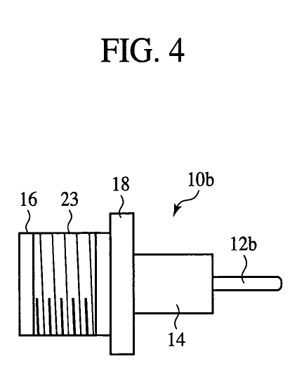

The coaxial connector according to a third embodiment of the present invention will be explained with reference to FIG. 4. FIG. 4 is a side view of the coaxial connector according to the present embodiment. In FIG. 4, the end of the terminal is illustrated in section. The same members of the present embodiment as those of the superconducting device according to the first or the second embodiment illustrated in FIGS. 1 to 3 are represented by the same reference numbers not to repeat or to simplify their explanation.

The superconducting device according to the present embodiment is characterized mainly in that the material of the terminal 12b of the coaxial connector 10b is Ag (silver).

As illustrated in FIG. 4, the terminal 12b of Ag is provided. No surface coating layer is formed on the surface of the terminal 12b of Ag. No surface coating layer is formed on the surface of the terminal 12b, because Ag itself forming the terminal 12b has good wettability with respect to an indium-based solder.

Ag, which is used as the material of the terminal 12b, is diffused into an indium-based solder which is used in the connection without deteriorating the flexibility of the indium-based solder. Thus, even when the terminal 12b of the coaxial connector 10b and the electrode 34 of the superconducting filter 26 are connected to each other with an indium-based solder, the flexibility of the indium-based solder is never deteriorated.

According to the present embodiment, as the material of the terminal 12b of the coaxial connector 10b, Ag which does not deteriorate the flexibility of an indium-based solder even when diffused into the indium-based solder is used, whereby the superconducting device according to the present embodiment can highly reliably endure repeated temperature changes between the room temperature and the lower temperatures.

(Modified Embodiments)

The present invention is not limited to the above-described embodiments.

For example, in the first and the second embodiments, indium is used as the material of the surface conducting layer 20 but is not essentially used. An indium alloy may be used.

In the second embodiments, Ni is used as the material of the terminal 12a, but the material of the terminal 12a is not limited to Ni. Any material can be used as long as the material is not easily diffused in an indium-based solder but can make the connection with the indium-based solder. Such material can be, e.g., Pd, Pt, an Ni and Fe alloy, and a Ni, Co and Fe alloy. A specific example of the Ni and Fe alloy is, e.g., 42 alloy. Specific examples of the Ni, Co and Fe alloy are, e.g., kovar, etc.

In the third embodiment, Ag is used as the material of the terminal 12b, but Ag is not essential. Materials which even when diffused in an indium-based solder, do not deteriorate the flexibility of the indium-based solder can be suitably used. For example., Ag alloys can be used.

In the above-described embodiments, the terminal 12 is immersed in an indium-based solder bath to thereby form the surface coating layer 20 on the surface of the terminal 12. The method for forming the surface coating layer 20 on the surface of the terminal 12 is not limited to the above. For example, by immersing the terminal 12 in an indium-based solder bath with supersonic waves applied to, the surface coating layer 20 of indium can be formed on the surface of the terminal 12. In using an indium-based solder bath with supersonic waves applied to, the surface coating layer 20 can be formed on the surface of the terminal 12 without applying a flux. The surface coating layer 20 can be formed on the surface of the terminal 12 by plating.

The coaxial connector according to the above-described embodiments has been exemplified by the coaxial connector of SMA type, but the present invention is applicable to any other type connector.

In the above-described embodiments, the superconducting filter 26 is mounted in the metal package 24, but not only the superconducting filter 26 but also any other superconducting element, such as superconducting resonators, superconducting antennas, etc., may be mounted in the metal package 24.

In the above-described embodiments, the superconducting filter 26 is mounted in the metal package 24, but not only the superconducting filter 26 but also any electronic devices may be mounted in the metal package 24.

### INDUSTRIAL APPLICABILITY

The present invention is applicable to coaxial connector and method for fabricating the coaxial connectors, and superconducting devices using the coaxial connectors and more specifically is useful for coaxial connectors and methods for fabricating the coaxial connectors having solder connections which can endure repeated temperature changes between the room temperature and lower temperatures and method for fabricating the coaxial connectors, and superconducting devices using the coaxial connectors.

1. A coaxial connector to be connected to a coaxial cable,
a surface coating layer of indium or an indium alloy being formed on the surface of a terminal of central conductor.

2. A coaxial connector according to claim 1, wherein
the terminal is formed of Cu or an Cu alloy.

3. A coaxial connector according to claim 1, wherein
the terminal is formed of Ni, Pd, Pt, an alloy of Ni and Fe or an alloy of Ni, Co and Fe.

4. A coaxial connector to be connected to a coaxial cable,
a terminal of central conductor being formed of Ag or an Ag alloy.

5. A method for fabricating a coaxial connector to be connected to a coaxial cable, comprising the step of
forming a surface coating layer of indium or an indium alloy on the surface of a terminal of central conductor.

6. A method for fabricating a coaxial connector according to claim 5, wherein
in the step of forming a surface coating layer, the terminal with a flux applied to is immersed in a solder bath to thereby form the surface coating layer on the surface of the terminal.

7. A method for fabricating a coaxial connector according to claim 5, wherein
in the step of forming a surface coating layer, the surface coating layer is formed on the surface of the terminal by immersing the terminal in a solder bath with supersonic waves applied to.

8. A method for fabricating a coaxial connector according to claim 5, wherein
in the step of forming a surface coating layer, the surface coating layer is formed on the surface of the terminal by plating.

9. A superconducting device comprising a coaxial connector to be connected to a coaxial cable, and a superconducting element to be connected to the coaxial cable by the coaxial connector,
a surface coating layer of indium or an indium alloy being formed on the surface of a terminal of central conductor of the coaxial cable, and
the terminal and an electrode of the superconducting element being connected to each other by an indium-based solder.

10. A superconducting device according to claim 9, wherein
the terminal is formed of Cu or a Cu alloy.

11. A superconducting device according to claim 9, wherein
the terminal is formed of Ni, Pd, Pt, an Ni and Fe alloy or an Ni, Co and Fe alloy.

12. A superconducting device comprising a coaxial connector to be connected to a coaxial cable, and a superconducting element to be connected to the coaxial cable by the coaxial connector,
a terminal of central conductor of the coaxial connector being formed of Ag or an Ag alloy.
